(19) United States
(12) Patent Application Publication
(10) Pub. No.: US 2025/0190840 A1
(43) Pub. Date: Jun. 12, 2025

(54) MANAGEMENT OF QUEUES FOR VARIOUS QUANTUM PROCESSING UNITS PROVIDED BY A QUANTUM COMPUTING SERVICE

(71) Applicant: Amazon Technologies, Inc., Seattle, WA (US)

(72) Inventors: Christian Bruun Madsen, Longmont, CO (US); Zia Mohammad, New York, NY (US); Viraj Vilas Chaudhari, Seattle, WA (US); Ramanathan Ramanathan, Vancouver (CA)

(73) Assignee: Amazon Technologies, Inc., Seattle, WA (US)

(21) Appl. No.: 18/532,930

(22) Filed: Dec. 7, 2023

(51) Int. Cl. G06N 10/80; G06N 10/40; G06N 20/00

(52) U.S. Cl. CPC G06N 10/80; G06N 10/40; G06N 20/00

(57) ABSTRACT

Techniques for tracking and maintaining queues used for executing pending quantum objects using respective quantum processing units (QPUs) are disclosed. An amount of time to execute a given quantum object depends on many factors, and a non-deterministic nature of quantum computing resources is such that, while knowing an expected wait time in a queue for access to a given QPU is useful, it is difficult to reliably determine. A quantum computing service that manages submission and execution of quantum objects to respective QPUs may apply QPU-specific machine learning models in order to predict expected wait times and provide that information to customers. By generating labeled datasets using ground truth wait times pertaining to already-executed quantum objects, respective machine learning models may be trained using a supervised learning technique, which may be a self-contained and re-occurring process.

### BACKGROUND

Quantum computing utilizes the laws of quantum physics to process information. Quantum physics is a theory that describes the behavior of reality at the fundamental level. It is currently the only physical theory that is capable of consistently predicting the behavior of microscopic quantum objects like photons, molecules, atoms, and electrons.

A quantum computer is a device that utilizes quantum physics to allow one to write, store, process and read out information encoded in quantum states, e.g., the states of quantum objects. A quantum object is a physical object that behaves according to the laws of quantum physics. The state of a physical object is a description of the object at a given time.

In quantum physics, the state of a two-level quantum system, or simply, a qubit, is a list of two complex numbers whose squares sum up to one. Each of the two numbers is called an amplitude, or quasi-probability, and their squared absolute values are probabilities that a measurement of the qubit results in zero or one. A fundamental and counterintuitive difference between a probabilistic bit (e.g., a classical zero or one bit) and the qubit is that a probabilistic bit represents a lack of information about a two-level classical system, while a qubit contains maximal information about a two-level quantum system.

Quantum computers are based on such quantum bits (qubits), which may experience the phenomena of “superposition” and “entanglement.” Superposition allows a quantum system to be in multiple states at the same time. For example, whereas a classical computer is based on bits that are either zero or one, a qubit may be both zero and one at the same time, with different probabilities assigned to zero and one. Entanglement is a strong correlation between quantum systems, such that the quantum systems are inextricably linked even if separated by great distances.

A quantum algorithm comprises a reversible transformation acting on qubits in a desired and controlled way, followed by a measurement on one or multiple qubits. For example, if a system has two qubits, a transformation may modify four numbers; with three qubits this becomes eight numbers, and so on. As such, a quantum algorithm acts on a list of numbers exponentially large as dictated by the number of qubits. To implement a transform, the transform may be decomposed into small operations acting on a single qubit, or a pair of qubits, as an example. Such small operations may be called quantum gates and a specific arrangement of the quantum gates implements a quantum circuit.

There are different types of qubits that may be used in quantum computers, each having different advantages and disadvantages. For example, some quantum computers may include qubits built from superconductors, trapped ions, semiconductors, photonics, etc. Each may experience different levels of interference, errors and decoherence. Also, some may be more useful for generating particular types of quantum circuits or quantum algorithms, while others may be more useful for generating other types of quantum circuits or quantum algorithms. Also, costs, run-times, error rates, availability, etc. may vary across quantum computing technologies.

### BRIEF DESCRIPTION OF THE DRAWINGS

FIG. 1 illustrates a service provider network that enables customers to compile and execute quantum circuits using multiple quantum computing technologies, according to some embodiments.

FIG. 2 illustrates queues for quantum processing units (QPUs) that are made available by the service provider network, wherein incoming requests from customers may be logically mapped into positions within the queues, according to some embodiments.

FIG. 3A illustrates an example of executing an incoming request from a customer, wherein the customer provides a quantum object that they are requesting to be executed along with associated metadata, and wherein, at a given timestep, a quantum computing service then logically maps the request into a queue for a given QPU, according to some embodiments.

FIG. 3B continues to illustrate the example of executing the incoming request, depicted in FIG. 3A, wherein, at later timestep, the quantum object is submitted for execution using the given QPU, according to some embodiments.

FIG. 3C further continues to illustrate the example of executing the incoming request, depicted in FIG. 3A, wherein, at yet another later timestep, execution results are obtained from a corresponding quantum hardware provider, and timing information is then used to generate another item in a labeled dataset, according to some embodiments.

FIG. 4A is a block diagram that illustrates a supervised learning training stage for a machine learning model used to predict wait times for QPU-specific queues, according to some embodiments.

FIG. 4B is another block diagram that illustrates using a trained implementation of the machine learning model to predict a wait time for an incoming customer request, according to some embodiments.

FIG. 5 illustrates some embodiments in which multiple queues per QPU may be used to logically map incoming requests from customers, according to some embodiments.

FIG. 6 is a flowchart illustrating a process of receiving an incoming request from a customer, generating an expected wait time in a queue using a machine learning model, and proceeding to submit the customer's request for execution, according to some embodiments.

FIG. 7 illustrates edge computing devices of a quantum computing service physically located at quantum hardware provider locations, according to some embodiments.

FIG. 8 illustrates an example edge computing device connected to a quantum computing service, according to some embodiments.

FIG. 9 illustrates example interactions between a quantum computing service and an edge computing device of the quantum computing service, according to some embodiments.

FIG. 10 is a block diagram illustrating an example classical computing device that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods and apparatus for managing queues associated with executing quantum objects using various quantum processing units (QPUs). Quantum computing resources are currently in high demand, as their utilities across various domains, from fundamental research, to financial and investment portfolios, are ever-increasing. In order to operate such a high throughput, a quantum computing service may be configured to receive incoming requests from customers, process their requests, and submit their requests to the various QPUs made accessible by said service. In order to balance and optimize such processes, the quantum computing service may be further configured to generate predicted wait times within the respective queues of quantum objects awaiting execution. Such timing information may be used by the service as a tracking mechanism for the current backlog with respect to the various QPUs, and may similarly be provided to customers in order to provide updated status checkpoints.

However, as the non-deterministic nature of quantum computing, along with many additional evolving factors such as speed, quality, and performance of quantum computing resources, make it difficult to reliably predict such wait times, such a quantum computing service may be further configured to train and subsequently implement a machine learning model that may be used to reliably and accurately provide predicted wait times in the queues. In some embodiments, the quantum computing service has a uniquely relevant access to the high throughput of incoming and outgoing customer requests that may allow it to generate its own labeled datasets that may then be used to train such machine learning models using supervised learning techniques. Furthermore, in order to account for QPU-specific performance metrics, QPU-specific recalibration rates, and other relevant parameters that may affect calculations of predicted wait times, the quantum computing service may train and implement QPU-specific machine learning models.

In some embodiments, a cloud-based, quantum computing service may orchestrate a process of optimizing selections of and load-balancing quantum task queues for various QPUs that are made accessible via a service provider network. Such a structure allows for customer requests for quantum task executions to be met in a customized and timely manner. Moreover, such a quantum computing service may be able to provide a highly relevant perspective of being able to cross-check recent QPU calibration data, characterization data, and current backlogs across both multiple QPUs and multiple different qubit technology groupings and in order to provide a comprehensive decision-making process starting from a moment in time at which a given quantum object is received to the service, until a moment in time at which execution results of the given quantum object are provided to the customer. Furthermore, and as introduced above, it may be unreasonable to expect for a customer to be able to deduce an expected wait time, given an amount of information and perspective needed to make such a calculation. However, the quantum computing service itself has unique access to a more global perspective, which allows it to train and utilize a machine learning model such that the model may efficiently and accurately predict expected wait times.

In addition, as such a quantum computing service may be configured to operate such quantum object submission processes in parallel, a time between when a given customer submits a request for executing a quantum task and when said customer receives execution results of said quantum task may be more efficiently managed. In some embodiments, a quantum computing service, such as that which is described herein, may multi-task receiving customer requests, evaluating and determining respective QPUs to execute said customer requests, and orchestrating submission and execution of said customer requests with various quantum hardware providers. By integrating such process steps into overall quantum object execution processes, the quantum computing service may provide more customized service to customers and also help ensure that their quantum object submissions are successfully executed.

In some embodiments, a system includes a service provider network comprising one or more computing devices that are configured to implement services of the service provider network such as a quantum computing service, and/or other services that relate to enabling customers of the service provider network to seamlessly select and use one or more quantum computing technologies to execute logical quantum circuits and/or quantum algorithms. In the methods and apparatus described herein, a quantum algorithm, a quantum program, and/or a quantum task may refer to one or more logical quantum circuits. For example, a quantum algorithm may comprise a second logical quantum circuit that depends on an outcome determined via a first logical quantum circuit, etc. An example quantum computing service is further described in the following paragraphs.

### Example Quantum Computing Service

Quantum computers may be difficult and costly to construct and operate. Also, there are varying quantum computing technologies under development with no clear trend as to which of the developing quantum computing technologies may gain prominence. A person having ordinary skill in the art may relate such current obstacles facing the scientific community as being relevant to a noisy intermediate-scale quantum (NISQ) hardware phase within the overall development, operation, and optimization of various quantum computing technologies. Thus, potential users of quantum computers may be hesitant to invest in building or acquiring a particular type of quantum computer, as other quantum computing technologies may eclipse a selected quantum computing technology that a potential quantum computer user may invest in. Also, successfully using quantum computers to solve practical problems may require significant trial and error and/or otherwise require significant expertise in using quantum computers. For example, within the NISQ hardware regime, quantum error correction and/or mitigation techniques are faced with the difficult task of developing methods for correcting single and multi-qubit errors, logical errors, and/or QPU specific qubit coherence time concerns, crosstalk noise levels, orchestration of control stack driven interactions, etc. Therefore, customers that are utilizing quantum computing resources may be concerned with repeatability and reliability of their quantum tasks that utilize such quantum computing resources.

As an alternative to building and maintaining a quantum computer, potential users of quantum computers may instead prefer to rely on a quantum computing service to provide access to quantum computers. Also, in some embodiments, a quantum computing service, as described herein, may enable potential users of quantum computers to access quantum computers based on multiple different quantum computing technologies and/or paradigms, without the cost and resources required to build or manage such quantum computers. Also, in some embodiments, a quantum computing service, as described herein, may provide various services (e.g., such as QPU selection module 128) that simplify the experience of using a quantum computer such that potential quantum computer users lacking deep experience or knowledge of quantum mechanics, may, nevertheless, utilize quantum computing services to solve problems.

Also, in some embodiments, a quantum computing service, as described herein, may be used to supplement other services offered by a service provider network. For example, a quantum computing service may interact with a classical computing service to execute hybrid algorithms (see also discussion pertaining to quantum object queues 500 herein). In some embodiments, a quantum computing service may allow a classical computer to be accelerated by sending particular tasks to a quantum computer for execution, and then further performing additional classical compute operations using the results of the execution of a quantum computing object on the quantum computer. For example, a quantum computing service may allow for the acceleration of virtual machines implemented on classical hardware in a similar manner as a graphics processing unit (GPU) may accelerate graphical operations that otherwise would be performed on a central processing unit (CPU).

In some embodiments, a quantum computing service may provide potential quantum computer users with access to quantum computers using various quantum computing technologies, such as quantum annealers, ion trap machines, superconducting machines, Rydberg atom arrays, photonic devices, etc. In some embodiments, a quantum computing service may provide customers with access to at least three broad categories of quantum computers including quantum annealers, circuit-based quantum computers, and analog or continuous variable quantum computers. As used herein, these three broad categories may be referred to as quantum computing paradigms and/or qubit technology groupings.

In some embodiments, a quantum computing service may be configured to provide simulation services using classical hardware-based computing instances to simulate execution of a quantum circuit on a quantum computer. In some embodiments, a quantum computing service may be configured to perform general simulation and/or simulation that specifically simulates execution of a quantum circuit on a particular type of quantum computer of a particular quantum computer technology type or paradigm type. In some embodiments, simulation may be fully managed by a quantum computing service on behalf of a customer of the quantum computing service. For example, the quantum computing service may reserve sufficient computing capacity on a virtualized computing service of the service provider network to perform simulation without customer involvement in the details of managing the resources for the simulator.

In some embodiments, a quantum computing service may include a dedicated console that provides customers access to multiple quantum computing technologies. Furthermore, the quantum computing service may provide a quantum algorithm development kit that enables customers with varying levels of familiarity with quantum circuit design to design and execute quantum circuits. In some embodiments, a console of a quantum computing service may include various application programmatic interfaces (APIs), such as:
(Create/Delete/Update/Get/List) Simulator-Configuration-create, read, update, and delete (CRUD) operations for simulator configuration objects.
(Start/Cancel/Describe) Simulator-used to control each of the user-defined simulator instances.
(List/Describe) quantum processor units (QPUs)-retrieves quantum computer hardware information.
(Create/Cancel/List/Describe) Job-used to manage the lifecycle of a quantum job.
(Assign/Update/List) Quality of Service (QOS) guarantee-used to manage QoS guarantees for quantum jobs and/or quantum tasks.
(Create/Cancel/List/Describe) Task-used to manage the lifecycle of individual quantum tasks/quantum objects.

In some embodiments, a quantum algorithm development kit may include a graphical user interface, APIs or other interface to allow customers of a quantum computing service to define quantum objects, such as quantum tasks, algorithms or circuits, using the quantum algorithm development kit. In some embodiments, the quantum algorithm development kit may include an interface option that enables customers to share the quantum objects with other customers of the quantum computing service. For example, the quantum algorithm development kit may include a marketplace that allows customers to share or sell particular quantum objects with other customers. In some embodiments, the quantum algorithm development kit may include an interface element that allows customers to select a quality of service (QOS) to be applied for a quantum job or quantum tasks defined via the quantum algorithm development kit.

In some embodiments, a quantum computing service may include a public application programmatic interface (API) that accepts quantum objects submitted by a customer of the quantum computing service. In some embodiments, the quantum computing service may accept via the public API, or another API, instructions regarding a QoS guarantee to be used for one or more quantum jobs or quantum tasks, such as executing the quantum object received via the public API. Additionally, the quantum computing service may include a back-end API transport that is non-public. The back-end API transport may enable quantum circuits to be transported from a centralized location that implements the quantum computing service, such as one or more data centers of a service provider network, to an edge computing device at a particular quantum hardware provider location where the quantum circuit is to be executed. In some embodiments, quantum objects or quantum tasks may be executed using an internal QPU of the quantum computing service without using a back-end API transport to transport the quantum job or quantum task to an external quantum hardware provider location.

In some embodiments, results of the execution of a quantum circuit on a quantum computer at a quantum hardware provider location may be provided to the edge computing device at the quantum hardware provider location. The edge computing device may automatically transport the results to a secure storage service of the service provider network, where the customer can access the results using the storage service of the service provider network or via a console of the quantum computing service. Likewise, results of execution of a quantum circuit via a local QPU (e.g., a QPU located within the service provider network) may be accessed via the console of the quantum computing service.

In some embodiments, the results stored to the secure storage service may be seamlessly used by other services integrated into the service provider network, such as a queue management module, a database service, an object-based storage service, a block-storage service, a data presentation service (that reformats the results into a more usable configuration), etc. For example, in some embodiments, a queue management module may access such stored execution results for use in generating labeled datasets for QPU-specific machine learning models, as described herein.

In some embodiments, a quantum computing service may support creating snapshots of results of executing a quantum circuit. For example, the quantum computing service may store snapshots of intermediate results of a hybrid algorithm or may more generally store snapshots of any results generated by executing a quantum circuit on a quantum computer. In some embodiments, an edge computing device at a hardware provider location may temporarily store results and may create snapshot copies of results stored on the edge computing device. The edge computing device may further cause the snapshot copies to be stored in an object-based data storage service of the service provider network. In some embodiments, snapshotting may not be performed, based on customer preferences.

Furthermore, as related to the description herein, it may be understood that quantum hardware, such as quantum hardware device(s), may be used to implement quantum computers, and/or various components of quantum computers (e.g., quantum processing units/cores, routing spaces, magic state distillation factories, other components used to perform logical quantum computations, etc.). For example, a given quantum hardware device may resemble “building blocks” of a quantum computer, such as a grid (e.g., a one-dimensional grid, a two-dimensional grid, etc.) of qubits that may be initialized in various ways in order to form various components of a quantum computer, such as topological quantum codes. Quantum hardware devices may be further configured such that single qubit gates, multi-qubit gates, and/or other operations of quantum circuits may be performed between qubits of the quantum hardware devices (according to a given physical qubit connectivity graph of the quantum hardware device which details which physical qubits are connected to respective other physical qubits via edges). A person having ordinary skill in the art should also understand that, depending upon factors such as type(s) of qubit technologies used, type(s) of gates performed between said qubits, etc., quantum hardware devices may also comprise various control devices (e.g., microwave pulse generators, devices for temperature, magnetic, and/or other environmental controls pertaining to local environments of the grid of qubits, etc.) that may be used to maintain and/or transform various properties of the qubits and/or other physical components of a given quantum computer. Moreover, a person having ordinary skill in the art should understand that a qubit may refer to both a logical bit (e.g., a one or a zero with some probability) and to one or more physical components used to construct the given qubit based, at least in part, on the type of qubit technology being applied. For example, a superconducting qubit (e.g., a transmon) may be constructed using at least a superconducting material and a non-superconducting material in which the non-superconducting material is located in between sections of superconducting material. With regard to this understanding, it should also be understood that quantum hardware may therefore be used to implement physical qubits, in ways such as those as described above, that may again be combined in various ways to implement one or more logical qubits such that logical quantum operations may be performed using said physical elements of said quantum hardware.

This written description continues with a general description of embodiments and implementations of generating predicted wait times for QPU-specific queues, including example implementations of such queues, example training and inference stages pertaining to machine learning models used to make such predictions, and examples of the integration of such techniques into larger interactions configured to be performed by the quantum computing service. Finally, a description of example computing system(s), such as classical computing devices, upon which the various components, modules, systems, and/or devices may be implemented is provided. Various examples are provided throughout the specification. A person having ordinary skill in the art should understand that the previous and following description of training and utilizing machine learning models for predicting wait times in QPU-specific queues is not to be construed as limiting as to the implementation of said structures, or portions thereof.

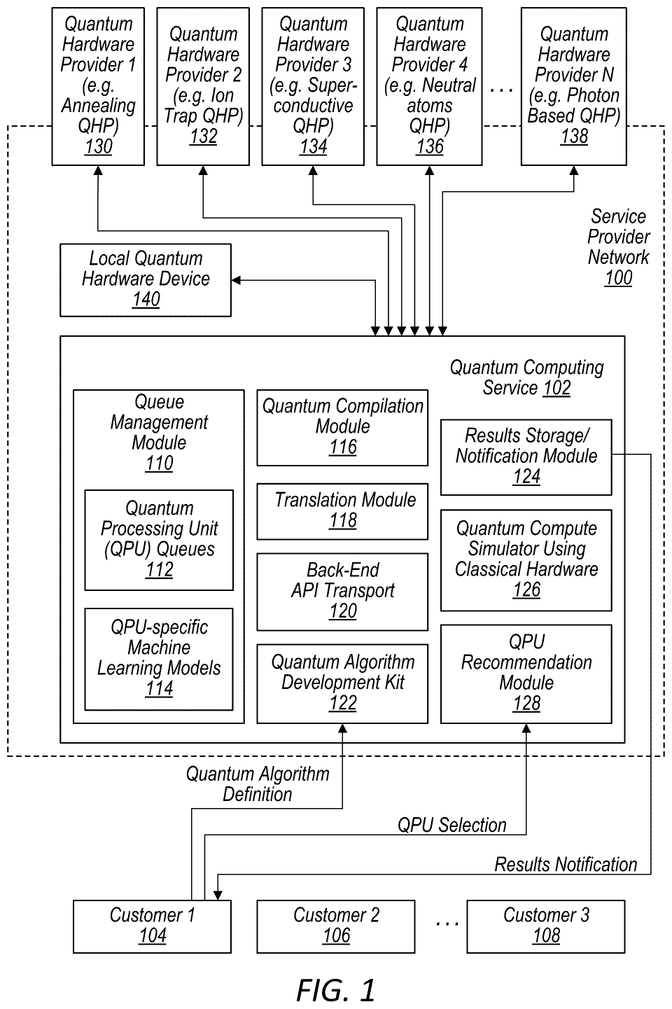

FIG. 1 illustrates a service provider network that enables customers to compile and execute quantum circuits using multiple quantum computing technologies, according to some embodiments.

In some embodiments, service provider network 100 may include various services, such as quantum computing service 102, in addition to one or more other services that pertain to quantum compilation, computation, and optimization, and that pertain to machine learning techniques for enhancement of said compilation, computation, and optimization, and in terms of customer-facing components of said services. In some embodiments, service provider network 100 may include data centers, routers, networking devices, etc., such as of a cloud computing provider network. In some embodiments, customers 104, 106, and 108, and/or additional customers of service provider network 100 and/or quantum computing service 102, may be connected to the service provider network 100 in various ways, such as via a logically isolated connection over a public network, via a dedicated private physical connection, not accessible to the public, via a public Internet connection, etc.

As introduced above, quantum computing service 102 may be configured to provide services to customers of service provider network 100, such that various quantum tasks of said customers may be executed using QPUs that are accessible via service provider network 100 (e.g., QPUs of quantum hardware providers 130, 132, 134, 136, and 138, local quantum hardware device 140, etc.), and/or may be simulated using classical computing device(s) that are accessible via service provider network 100 (e.g., via computing device 1000).

In some embodiments, a quantum computing service 102 may include a queue management module 110, a quantum compilation module 116, a translation module 118, a back-end API transport 120, a quantum algorithm development kit 122, a results storage module 124, a quantum compute simulator using classical hardware 126, and a QPU recommendation module 128. Also, quantum computing service 102 is connected to quantum hardware providers 130, 132, 134, 136, and 138. In some embodiments, quantum hardware providers 130, 132, 134, 136, and 138 may offer access to run quantum objects on quantum computers that operate based on various different types of quantum computing technologies or paradigms, such as based on quantum annealing, ion-trap, superconductive materials, neutral atoms, photons, etc.

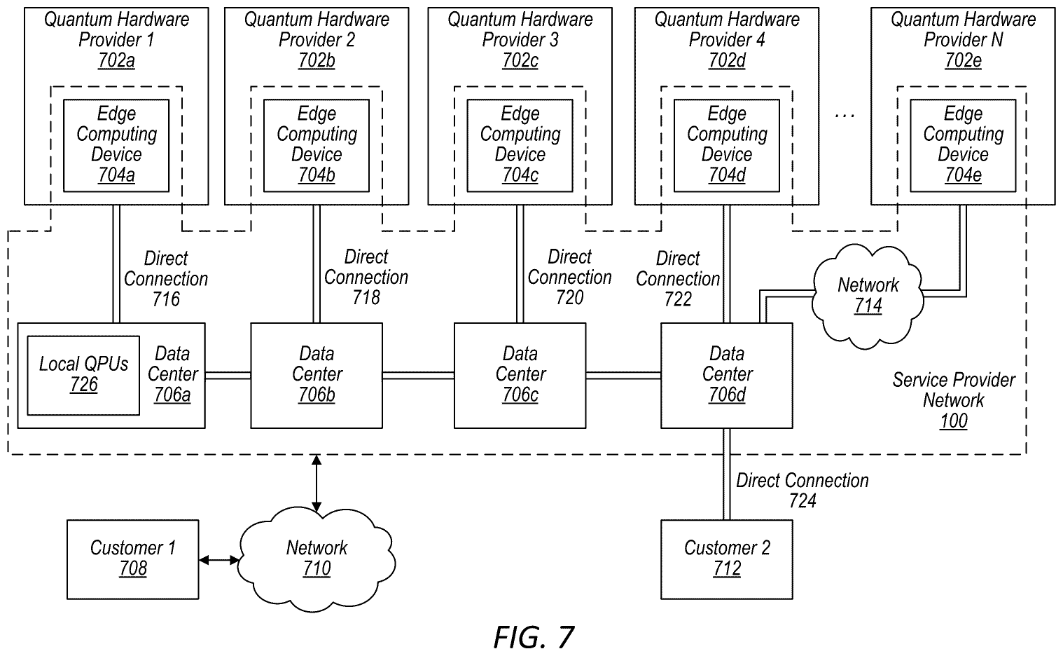

As discussed in additional detail in FIG. 7, in some embodiments, a service provider network 100 may be extended to include one or more edge computing devices physically located at quantum hardware provider locations, such as in a facility of quantum hardware providers 130, 132, 134, 136, and 138. Physically locating (e.g., co-locating) an edge computing device of a service provider network 100 on premises at a quantum hardware provider facility may extend data security and encryption of the service provider network 100 into the quantum hardware providers 130, 132, 134, 136, and 138 facilities, thus ensuring the security of customer data. Also, physically locating an edge computing device of a service provider network 100 on premises at a quantum hardware provider facility may reduce latency between a compute instance of the service provider network and a quantum computer located at the quantum hardware provider facility. Thus, some applications, such as hybrid algorithms that are sensitive to network latencies may be performed by quantum computing service 102, whereas other systems without co-located classical compute capacity at a hardware provider location may have too high of latencies to perform such hybrid algorithms efficiently.

In some embodiments, quantum computing service 102 includes one or more back-end API transport modules 120. In some embodiments, a back-end API transport module 120 may be primarily implemented on edge computing devices of the quantum computing service that are located at the quantum hardware provider locations (such as edge computing devices 704a, 704b, 704c, 704d, and 704e illustrated in FIG. 7). Also, in some embodiments, at least some of the back-end API transport functionality may be implemented on the one or more computing devices of the service provider network that implement the quantum computing service (such as computing devices in data centers 706a, 706b, 706c, and 706d illustrated in FIG. 7). In some embodiments, different quantum hardware providers may require different back-end API transport modules, which may further add variability to execution durations of quantum tasks. Some quantum hardware providers may accept quantum tasks over a network via an API such that it is not necessary for the provider network to locate an edge computing device at the quantum hardware provider's facility in order to submit quantum tasks. In some embodiments, some quantum hardware providers may follow a first in first out (FIFO) execution model for quantum tasks submitted for execution to the quantum hardware provider. Other quantum hardware providers may follow a batch execution model. In order to deal with these execution duration variabilities and to further deal with execution duration variability due to characteristics of various quantum tasks (e.g. number of shots, quantum circuit size, number of gates, time to switch between quantum circuits, etc.), a priority access control plane may order quantum tasks submitted to the back-end API transports for various quantum hardware providers in a prioritized order such that quality of service (QOS) guarantees and other scheduling rules are followed.

In some embodiments, service provider network 100 may also include quantum compilation module 116. Quantum compilation module 116 may orchestrate one or more intermediate compilations (e.g., a compilation mapping of a logical quantum circuit to a given quantum hardware device structure, a compilation of gate nativization(s), translation of a quantum circuit into a quantum circuit specific to a given quantum hardware provider's design/language/architecture/technology, etc.) that may be used in order to take an input logical quantum circuit and conduct, via quantum computing service 102, the execution of said circuit using a given QPU of a given quantum hardware provider. For example, some two-qubit gates of a given logical quantum circuit may be decomposed into a series of native gates, and quantum compilation module 116 may be configured to treat such decompositions. In yet another example, in some embodiments in which a quantum hardware provider of quantum hardware providers 130-138 pertains to Rydberg atom arrays, other quantum compilation module 116 may be configured to compile and/or encode a mapping problem for determining atomic computational positions in Rydberg atom arrays, according to some embodiments.

Quantum computing service 102 may also be configured to translate (e.g., via translation module 118) a given quantum computing object into a selected quantum circuit format for a particular quantum computing technology used by the selected quantum hardware provider or local QPU, wherein the selected quantum circuit format for the particular quantum computing technology is one of a plurality of quantum circuit formats for a plurality of different quantum computing technologies supported by the quantum computing service. To translate the quantum computing object into the selected quantum circuit format, the one or more computing devices that implement the quantum computing service are configured to identify portions of the quantum computing object corresponding to quantum operators in an intermediate representation in which the quantum object was submitted by the customer, substitute the quantum operators of the intermediate representation with quantum operators of the quantum circuit format of the particular quantum computing technology, and perform one or more optimizations to reduce an overall number of quantum operators in a translated quantum circuit that is a translated version of the received quantum computing object. Additionally, quantum computing service 102 may be configured to provide the translated quantum circuit for execution at a quantum hardware provider or internal QPU that uses the particular quantum computing technology; receive, from the quantum hardware provider or internal QPU, results of the execution of the translated quantum circuit; and provide a notification to a customer of the quantum computing service that the quantum computing object has been executed.

Quantum circuits that have been translated by translation module 118 may be provided to back-end API transport module 120 in order for the translated quantum circuits to be transported to a quantum computer at a respective quantum hardware provider location. In some embodiments, back-end API transport 120 may be a non-public API that is accessible by an edge computing device of service provider network 100, but that is not publicly available. In some embodiments, edge computing devices at the quantum hardware providers 130, 132, 134, 136, and 138 may periodically ping a QPU service side interface to the back-end API transport 120 to determine if there are any quantum circuits (or batches of quantum circuits) waiting to be transported to the edge computing device (see also description pertaining to FIG. 7 herein). If so, the edge computing device may perform an API call to the back-end API transport 120 to cause the quantum circuit to be transported over a private connection to the edge computing device and scheduled for execution on a QPU. Also, the edge computing device may have been configured with a quantum machine image that enables the edge computing device to interface with a scheduling application of the quantum hardware provider, where the edge computing device is located, in order to schedule a time slot on the QPU of the quantum hardware provider to execute the quantum circuit via the back-end API transport 120.

In some embodiments, results of executing the quantum circuit on a given QPU at the quantum hardware provider location may be returned to the edge computing device at the quantum hardware provider location. The edge computing device and/or quantum computing service 102 may cause the results to be stored in a data storage system of the service provider network 100. In some embodiments, results storage/results notification module 124 may coordinate storing results and may notify a customer, such as customer 104, that the results are ready from the execution of the customer's quantum object, such as a quantum task, quantum algorithm, or quantum circuit. In some embodiments, results storage/results notification module 124 may cause storage space in a data storage service to be allocated to a customer to store the customer's results. Also, the results storage/results notification module 124 may specify access restrictions for viewing the customer's results in accordance with customer preferences.

In some embodiments, quantum compute simulator using classical hardware 126 of quantum computing service 102 may be used to simulate a quantum algorithm or quantum circuit using classical hardware. For example, one or more virtual machines of a virtual computing service may be instantiated to process a quantum algorithm or quantum circuit simulation job. In some embodiments, quantum compute simulator using classical hardware 126 may fully manage compute instances that perform quantum circuit simulation. For example, in some embodiments, a customer may submit a quantum circuit to be simulated and quantum compute simulator using classical hardware 126 may determine resources needed to perform the simulation job, reserve the resources, configure the resources, etc. In some embodiments, quantum compute simulator using classical hardware 126 may include one or more “warm” simulators that are pre-configured simulators such that they are ready to perform a simulation job without a delay typically involved in reserving resources and configuring the resources to perform simulation.

In some embodiments, quantum algorithm development kit 122 of quantum computing service may be implemented as a graphical user interface, wherein a customer of service provider network 100 may upload and/or provide quantum computing service 102 with various information regarding a request for execution of a given quantum algorithm on a QPU that is accessible via service provider network 100. However, quantum algorithm development kit 122 may also be implemented as various types of programmatic (e.g., Application Programming Interfaces (APIs)) or command line interfaces to support the methods and systems described herein, according to some embodiments. Furthermore, quantum algorithm development kit 122 may be a customer-facing interface in which a customer of quantum computing service 102 may submit inputs to be used for a given quantum circuit execution. A customer of quantum computing service 102 may also request that a given quantum task that they provide to quantum computing service 102 be executed using QPU(s) of a given quantum hardware provider (e.g., quantum hardware provider 130, 132, 134, 136, 138, etc.). As part of the fulfillment of said request, the given quantum task may be divided into one or more logical quantum circuits that represent intermediate logical computations used within the overall quantum algorithm, then those logical quantum circuit(s) may then be used in order to generate quantum circuit mapping(s) of the logical quantum circuit(s) to quantum hardware device(s) of a given quantum hardware provider.

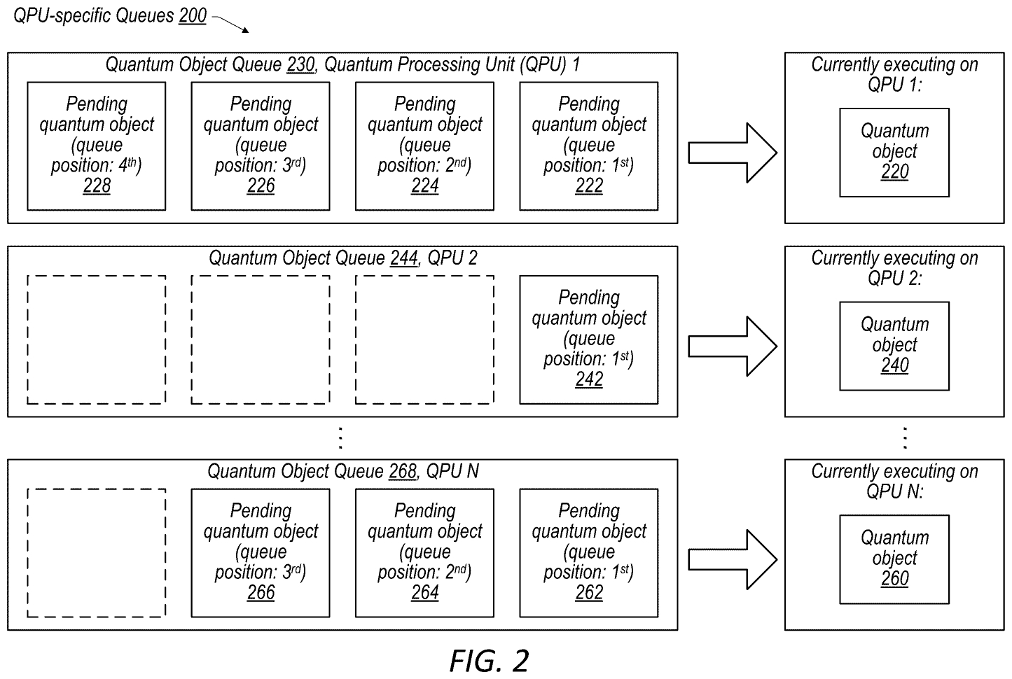

FIG. 2 illustrates queues for quantum processing units (QPUs) that are made available by the service provider network, wherein incoming requests from customers may be logically mapped into positions within the queues, according to some embodiments.

As shown in FIG. 2, quantum object queues of corresponding QPUs that have been made available by service provider network 100 may be maintained and tracked by queue management module 110 of quantum computing service 102, according to some embodiments. In some embodiments, queue management module 110 may maintain and track QPU-specific queues, such that numbers of pending quantum objects, predicted wait times, and/or backlogs may be viewed and deduced both on a QPU-specific basis and on a more global basis across some or all of customer requests for execution of various quantum objects that have been submitted to quantum computing service 102.

For example, at a given moment in time depicted in FIG. 2, QPUs 1, 2, and N have respective quantum objects that have already been submitted for execution via quantum computing service 102 (see quantum objects 220, 240, and 260), and, in some embodiments as shown in FIG. 2, may be interpreted as currently running on QPUs 1, 2, and N, respectively. Furthermore, at the given moment in time depicted in FIG. 2, QPU 1 has pending quantum objects 222, 224, 226, and 228 within quantum object queue 230, QPU 2 has pending quantum object 242 within quantum object queue 244, and QPU N has pending quantum objects 262, 264, and 266 within quantum object queue 268.

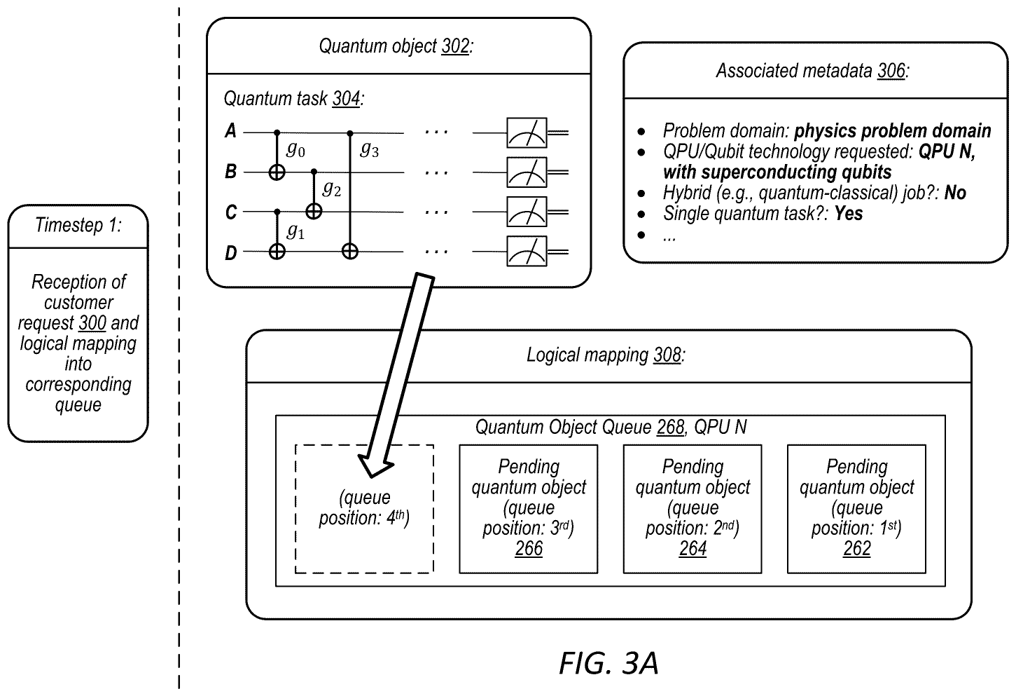

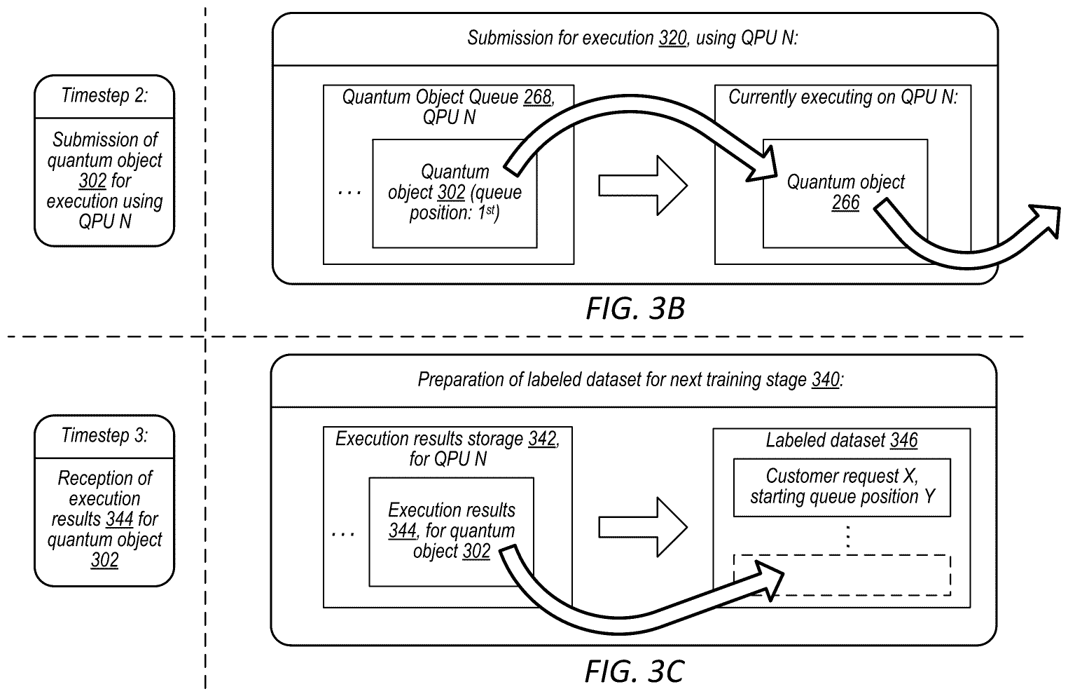

In some embodiments, and as additionally depicted in FIG. 2, incoming customer requests to execute respective quantum objects may be logically mapped to positions in respective queues by queue management module 110 of quantum computing service 102. For example, pending quantum object 222 is currently logically mapped to a first position in quantum object queue 230 for QPU 1, wherein a first position may refer to submitting pending quantum object 222 for execution upon completion of the execution of quantum object 220, which is currently being executed at a given moment in time depicted in FIG. 2. It should be understood that an additional incoming customer request may be logically mapped, initially, to a given position in a queue, but that, as other pending quantum objects in front of the incoming customer request proceed to be executed using the corresponding QPU, the incoming customer request may then be re-mapped to a different position in the queue. For example, quantum object 220 is shown as being currently executing at a moment in time depicted in FIG. 2. However, quantum object 220 may have been initially logically mapped to a 5^{th} place position in quantum object queue 230, and then, at a later moment in time, to a 4^{th} place position, and so on until said object began executing using QPU 1. Such embodiments are additionally discussed herein with regard to quantum object 302 throughout various timesteps depicted in FIGS. 3A-3C.

Furthermore, it should additionally be understood that variation in a number of quantum circuits to be executed within a given quantum object, a depth of the quantum circuit(s), a number of times that execution of the quantum circuit(s) is to be repeated (which may also be referred to herein as a number of “shots” per quantum circuit), a type of qubit technology the quantum object is executed using, a state of said QPU (e.g., a QPU that has been recently recalibrated vs a QPU which has degraded in performance since the last recalibration, etc.), in addition to other compounding and/or interrelated variables may cause pending quantum objects to be processed through the respective queue faster or slower than other pending quantum objects to be processed through a different queue. For example, due to any combination of the above-mentioned and interrelated variables, even though quantum object queue 230 may have three more pending quantum objects than quantum object queue 244 does at a moment in time depicted in FIG. 2, quantum object queue 230 may still process through execution of the four pending quantum objects in the queue at a faster rate than a rate at which quantum object queue 244 may process through execution of the one pending quantum object in the queue, according to some embodiments. As there may be a large number of variables that may influence a speed at which quantum computing service 102 may process pending quantum objects through the various queues corresponding to the plurality of QPUs that are made available through service provider network 100, QPU-specific machine learning models 114 may be applied for predicting expected wait times that customers of quantum computing service 102 may be expected to wait until receiving their execution results.

In some embodiments, pending quantum objects may remain logically mapped within a given quantum object queue until a moment at which it transitions from being in a first position within the queue to being submitted, at which point execution may begin using the corresponding QPU. However, in other embodiments, several quantum objects may be submitted at once in a “batch” form to a quantum hardware provider, and, even though logically mapped positions in the queue may still be tracked and maintained by queue management module 110, said pending quantum objects may already have been submitted for execution. Similarly, quantum computing service 102 may receive execution results for multiple executed quantum objects in a “batch” form from a quantum hardware provider, and may still be able to determine a moment in time at which a given quantum object began executing, a moment in time at which the given quantum object completed execution, etc. Such determinations may be used to generate a labeled dataset for the corresponding QPU-specific machine learning model that may be used to predict expected wait times.

Additional embodiments of QPU-specific queues are further described with regard to quantum object queues 500 herein.

FIG. 3A illustrates an example of executing an incoming request from a customer, wherein the customer provides a quantum object that they are requesting to be executed along with associated metadata, and wherein, at a given timestep, a quantum computing service then logically maps the request into a queue for a given QPU, according to some embodiments.

In some embodiments, quantum computing service 102 may receive an incoming request from a customer to execute their quantum object using a given QPU at a moment in time depicted in FIG. 3A. In some embodiments, such an incoming request may include both a quantum object, such as quantum object 302, and metadata associated either with the customer themself, with the quantum object, or both. As described throughout timesteps 1, 2, and 3 which correspond to FIGS. 3A, 3B, and 3C herein, information pertaining to both quantum object 302 and to associated metadata 306 may be referenced at various stages of preparation, translation, submission, and execution, of that particular customer request. Furthermore, such information may collectively be used across multiple customer requests in order to generate a labeled dataset to be used to train or re-train a machine learning model.

In some embodiments, customer request 300 may include information pertaining to description of their quantum object 302. For example, quantum object 302 may resemble that which is shown in FIG. 3A, wherein quantum gates (e.g., g₀, g₁, g₂, g₃, etc.) may be performed across respective logical qubits (e.g., A, B, C, D) in succession, followed by qubit readouts and/or measurements. Quantum object 302 may include more or less logical qubits, more or less quantum gates, and/or more or less quantum circuits than that which is shown in FIG. 3A, and quantum computing service 102 may still be configured to prepare customer request 300 for submission and execution using a given QPU made available via service provider network 100.

In some embodiments, customer request 300 may include additional information that assists in preparing customer request 300 for submission and execution. For example, as shown in associated metadata 306 in FIG. 3A, a customer may specify that quantum object 302 is to be executed using a specific QPU (e.g., QPU N), or that quantum object 302 is to be executed using any QPU implemented using a specific type of qubits (e.g., superconducting qubits), or that quantum object 302 is to be executed using a QPU that currently has the shortest expected wait time, etc. In another example, associated metadata 306 may include information pertaining to the customer that is submitting customer request 300, such as an indication that the customer is an academic professor at a university, or that the customer represents a finance corporation, or that the customer is a first-time user of quantum computing resources of quantum computing service 102, etc. In yet another example, associated metadata 306 may include information about a problem domain that their quantum object pertains to, such as an optimization problem domain, a manufacturing problem domain, a physics problem domain, a chemistry problem domain, a finance problem domain, a pharmaceutical problem domain, a biotechnology problem domain, a medical problem domain, an information security problem domain, a machine learning problem domain, an artificial intelligence problem domain, etc.

In some embodiments, associated metadata 306 may additionally include information that has been added by quantum computing service 102, wherein the information has been deduced, determined, or otherwise analyzed by the service and subsequently linked to customer request 300. For example, quantum computing service 102 may receive quantum object 302 and determine that said quantum object includes 1, 2, 3, etc. quantum circuits that are to be repeated 1, 2, 3, etc. times during execution. In some embodiments, any number of quantum circuits, comprised within a quantum object, that are to be executed sequentially may be defined herein as a single quantum task. In another example, quantum computing service 102 may receive quantum object 302 and determine that said quantum object is a hybrid, quantum-classical job, wherein at least a portion of the execution may be performed using a QPU and at least another portion of the execution may be performed using a classical computing device. In some embodiments, a hybrid, quantum-classical job may be defined herein as any number of quantum circuits that are executed using a QPU, in association with a classical computing device. For example, in order to converge on defining a minimum energy of a molecule or some other physical system, a plurality of quantum circuits may be executed in order to calculate electronic energies, while also optimizing such calculations using a classical computing resource. In another example, a hybrid, quantum-classical job may be structured for some optimization technique, wherein quantum circuits may be applied in order to evaluate a given cost function in conjunction with a classical computing resource.

Furthermore, quantum computing service 102 may be configured to receive quantum object 302 and use information provided within quantum object 302 to determine such associated metadata about the quantum object, according to some embodiments. However, in some embodiments, quantum computing service 102 may be further configured to receive quantum object 302 and receive additional indications from the customer that pertain to their quantum object being a single quantum task, a hybrid quantum-classical job, etc.

In some embodiments, at least some of the information included in associated metadata 306 may resemble categorical data that may be used as inputs for training and/or re-training a QPU-specific machine learning model.

As shown in FIG. 3A, timestep 1 may include a reception of customer request 300 and a logical mapping 308 into quantum object queue 268 for QPU N. In example embodiments shown in FIG. 3A, associated metadata 306 indicates that quantum object 302 is to be executed using QPU N. Therefore, upon reception of incoming customer request 300, quantum object 302 may subsequently be logically mapped into a position in a queue corresponding to QPU N, such as quantum object queue 268, introduced in FIG. 2. As indicated by the arrow in FIG. 3A, quantum object queue 268 currently already has three pending quantum objects at a moment in time depicted in FIGS. 2 and 3A, and therefore quantum object 302 may be logically mapped to a fourth position in the queue, just following pending quantum object 266.

In some embodiments, timestep 1 may also refer to a moment in time in which QPU recommendation module 128 provides a recommendation for a QPU selection to the customer. For example, if the customer submits customer request 300 but does not indicate a specific QPU that they would like used to execute quantum object 302, or indicates a type of qubit technology that they would like used but not a specific QPU, or provides no indication of which QPU they would like used, QPU recommendation module 128 may be configured to provide a QPU selection recommendation. In some embodiments, QPU recommendation module 128 may reference quantum object queues 230, 244, and 268 in order to determine which QPUs currently have more backlog than other QPUs, which QPUs may be able to complete execution of quantum object 302 in a shorter timeframe than other QPUs, etc. Furthermore, in order to gather such timing-related information, QPU recommendation module 128 may cause various machine learning models within QPU-specific machine learning models 114 to generate predicted wait times for the various queues, and provide said predicted wait times within the recommendation to the customer. The customer may then use such information to select which QPU they would like used to execute quantum object 302.

In another example, if the customer submits customer request 300 and indicates that they would like quantum object 302 executed on a QPU that currently has the shortest predicted wait time, QPU recommendation module 128 may cause various machine learning models within QPU-specific machine learning models 114 to generate predicted wait times for the various queues, and select the QPU that has the shortest predicted wait time to be used to execute quantum object 302. Similarly, if, at a later moment in time prior to submission of quantum object 302, another pending quantum object is canceled, or if quantum object 302 becomes demoted within a queue (see also description herein pertaining to priority access), then QPU recommendation module 128 may be further configured to logically map quantum object 302 to a different queue that now has a shorter expected wait time.

FIG. 3B continues to illustrate the example of executing the incoming request, depicted in FIG. 3A, wherein, at later timestep, the quantum object is submitted for execution using the given QPU, according to some embodiments.

At a timestep 2, depicted in FIG. 3B, a given amount of time has elapsed since quantum object 302 has been initially logically mapped to the fourth position in quantum object queue 268, and said quantum object is now currently logically mapped to a first position in the queue. Upon completion of the currently executing quantum object (e.g., quantum object 266), execution of quantum object 302 using QPU N may begin, as indicated by the arrows in FIG. 3B.

In some embodiments, an amount of time that a customer corresponding to customer request 300 waits in the queue for their quantum object 302 to begin execution may be defined as a time that has elapsed between the initial reception of customer request 300 by quantum computing service 102 (e.g., timestep 1, depicted in FIG. 3A) and a moment in time at which execution of quantum object 302 begins (e.g., timestep 2, depicted in FIG. 3B). As further illustrated in FIG. 3C herein, an amount of time that a customer corresponding to customer request 300 waits to receive execution results pertaining to quantum object 302 may be defined as a time that has elapsed between the initial reception of customer request 300 by quantum computing service 102 (e.g., timestep 1, depicted in FIG. 3A) and a moment in time at which execution results are received by quantum computing service 102 from a quantum hardware provider corresponding to QPU N (e.g., timestep 3, depicted in FIG. 3C). In some embodiments, a machine learning model may be used to predict wait times, wherein the predicted wait times may correspond to a time that has elapsed between timestep 1, depicted in FIG. 3A, and timestep 2, depicted in FIG. 3B, or wherein the predicted wait times may correspond to a time that has elapsed between timestep 1, depicted in FIG. 3A, and timestep 3, depicted in FIG. 3C. Furthermore, in some embodiments, such definitions of “predicted wait times” may vary per quantum hardware provider, per QPU, or per customer, depending upon the availability of information (e.g., timestamps pertaining to the beginning of execution, end of execution, other notifications of progress steps during execution, etc.) that is provided by respective ones of the quantum hardware providers and/or depending upon types of information that is more pertinent to respective customers of quantum computing service 102 (e.g., certain customers may want to know at what time they should expect that they will be able to log back in and see their completed execution results, certain customers may want to know at what time they should expect that they can log back in and potentially receive updates about the progress of their currently executing quantum object, etc.).

FIG. 3C further continues to illustrate the example of executing the incoming request, depicted in FIG. 3A, wherein, at yet another later timestep, execution results are obtained from a corresponding quantum hardware provider, and timing information is then used to generate another item in a labeled dataset, according to some embodiments.

At a timestep 3, depicted in FIG. 3C, a given amount of time has elapsed since quantum object 302 began executing on QPU N, and execution results 344 are now currently being received by quantum computing service 102. As shown in FIG. 3C, quantum computing service 102 may be configured to receive, from a quantum hardware provider corresponding to QPU N, execution results 344 for quantum object 302 and store said results in execution results storage 342. Execution results 344 may then be provided to the customer corresponding to quantum object 302.

Furthermore, one or more components of execution results 344 may be used to generate an additional item within labeled dataset 346, which may then be used to re-train a machine learning model at some later moment in time (see also description pertaining to supervised learning training stage 400 herein). For example, as introduced above, in some embodiments in which a “predicted wait time” may be defined as a time that has elapsed between timesteps 1 and 2, or between timesteps 1 and 3, execution results 344 may provide indications of timestamps associated with timesteps 2 and/or 3 (e.g., a timestamp associated with the beginning of the execution of quantum object 302, a timestamp associated with the completion of the execution of quantum object 302, etc.). As such, quantum computing service 102 may be configured to determine a ground truth wait time for quantum object 302 based, at least in part, on time markers associated with a combination of timesteps 1, 2, and 3 depicted within FIGS. 3A-3C herein. As such determined ground truth wait times correspond to actual wait times that quantum object 302 spend in a queue, and/or until completion of the execution on QPU N, depending upon various implementations of “predicted wait times,” they may be used to generate a labeled dataset, for training and/or re-training a machine learning model using a supervised learning technique.

Moreover, it may be understood that timestep 3, depicted in FIG. 3C, may additionally correspond to a moment in time at which an additional pending quantum object which was logically mapped to a position just behind quantum object 302 in quantum object queue 268 may now begin executing on QPU N, since quantum object 302 has now finished executing.

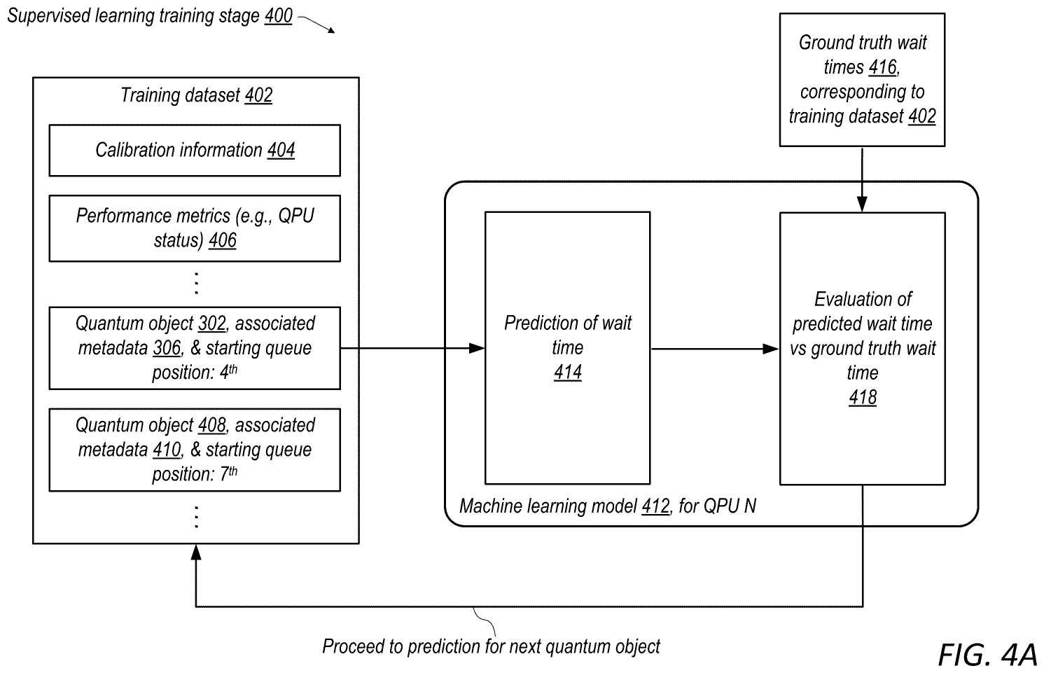

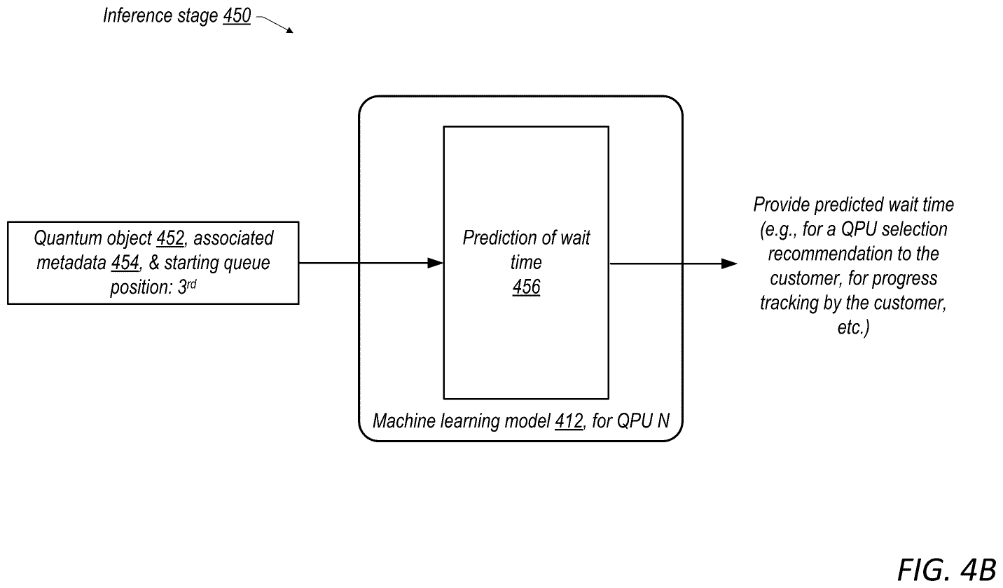

FIG. 4A is a block diagram that illustrates a supervised learning training stage for a machine learning model used to predict wait times for QPU-specific queues, according to some embodiments.

In some embodiments, a given QPU-specific machine learning model of QPU-specific machine learning models 114, such as machine learning model 412, may be trained specifically for predicting wait times in queue(s) associated with QPU N. As shown in FIG. 402, machine learning model 412 may be provided with data items within training dataset 402, and may then be configured to generate predicted wait times for the various customer request scenarios provided within training dataset 402. For example, data items pertaining to customer request 300, introduced above with regard to FIGS. 3A-3C, may be provided to machine learning model 412, as indicated by the block comprising quantum object 302, associated metadata 306, and starting queue position: fourth, shown in FIG. 4A. Using such inputs, machine learning model 412 may predict an expected wait time for that particular customer request scenario, as indicated by prediction of wait time 414. As then illustrated by evaluation of predicted wait time vs ground truth wait time 418, the predicted wait time generated by machine learning model is then compared to the ground truth wait time that the customer corresponding to quantum object 302 actually waited for. A difference between the predicted wait time and the ground truth wait time is then used to adjust weightings within machine learning model 412 prior to implementation for use in predicting wait times using unlabeled data items (e.g., see also inference stage 450).

As indicated by the arrow labeled as “proceed to prediction for next quantum object” in FIG. 4A, machine learning model 412 may then be provided with quantum object 408, associated metadata 410, and starting queue position: seventh, and begin predicting a wait time associated with said particular scenario, and so on.

In some embodiments, ground truth wait times 416, depicted in FIG. 4A, may resemble some of the items illustrated in labeled dataset 346, depicted in FIG. 3C. For example, execution results 344 may be used to determine a ground truth wait time associated with quantum object 302, and then may be inserted into labeled dataset 346 and applied during supervised learning training stage 400. Furthermore, as training dataset 346 resembles labeled data items that are used to train machine learning model 412, it may be understood that machine learning model 412 is trained using a supervised learning technique. In some embodiments, various supervised learning techniques may be implemented in order to train machine learning model 412, such as decision trees, Random Forest, a Naïve Bayes approach, a K-nearest-neighbors (K-NN) approach, ensemble learning techniques, linear regression techniques, etc.

In some embodiments, training dataset 402 may further include data items such as calibration information 404 and performance metrics 406. For example, a given QPU may have degraded to a point of requiring a recalibration between a moment in time at which point quantum object 302 was received by quantum computing service 102 and a moment in time at which point quantum object 408 was received, and it therefore may be relevant to reference such updated calibration information when predicting wait times of either quantum object 302 and/or quantum object 408. In another example, various performance metrics pertaining to a status of QPU N may be relevant for training machine learning model 412. For instance, characterization of device performance, of speed of device performance, of quality of device performance, etc. may be incorporated into supervised learning training stage 400 as performance metrics. Furthermore, as a device degrades over its overall lifetime, as calibration drifts over time, as one or more physical qubits get replaced, etc., overall performance metrics of the QPU may be used to provide an overall indication of a status of the device at a moment in time that quantum objects within training dataset 402 were processed through quantum computing service 102.

In some embodiments, one or more of the data items within training dataset 402 may be referred to as categorical data. For example, associated metadata may include an indication of a given problem domain associated with the corresponding quantum object. In another example, various performance metrics may be provided as categorical data and/or may be metrics that are relative to one another, and therefore may be perceived as categorical data by machine learning model 412.

FIG. 4B is another block diagram that illustrates using a trained implementation of the machine learning model to predict a wait time for an incoming customer request, according to some embodiments.

In some embodiments, once machine learning model 412 has been trained during supervised learning training stage 400, it may then be implemented for use by quantum computing service 102 to predict wait times corresponding to new incoming customer requests that pertain to QPU N. As illustrated by inference stage 450 in FIG. 4B, a new (e.g., previously unsubmitted to quantum computing service 102) quantum object 452 and associated metadata 454 have just been received by quantum computing service 102 at a moment in time depicted in FIG. 4B. In addition, queue management module 110 has just logically mapped quantum object 452 into a third place position in a given queue corresponding to QPU N. In some embodiments, quantum object 452, associated metadata 454, and a corresponding placement into a third place position may resemble unlabeled data, as said components are part of a new incoming customer request at a moment in time depicted in FIG. 4B, and wherein no corresponding ground truth wait time has previously been determined by quantum computing service 102.

In some embodiments, upon receiving quantum object 452, associated metadata 454, and a corresponding placement into a third place position of a queue corresponding to QPU N, machine learning model 412 may generate a predicted wait time, as indicated via prediction of wait time 456 in FIG. 4B. Subsequently, said predicted wait time may then be provided to a customer corresponding to quantum object 452, may be used to provide a QPU selection recommendation to said customer, and/or may be utilized by various other modules and services of quantum computing service 102. Furthermore, at a later moment in time at which point quantum computing service 102 determines a ground truth wait time associated with an execution of quantum object 452, a given scenario defined by quantum object 452, associated metadata 454, and a corresponding placement into a third place position of a queue corresponding to QPU N may be incorporated into an additional labeled dataset that may then be used to re-train machine learning model 412.

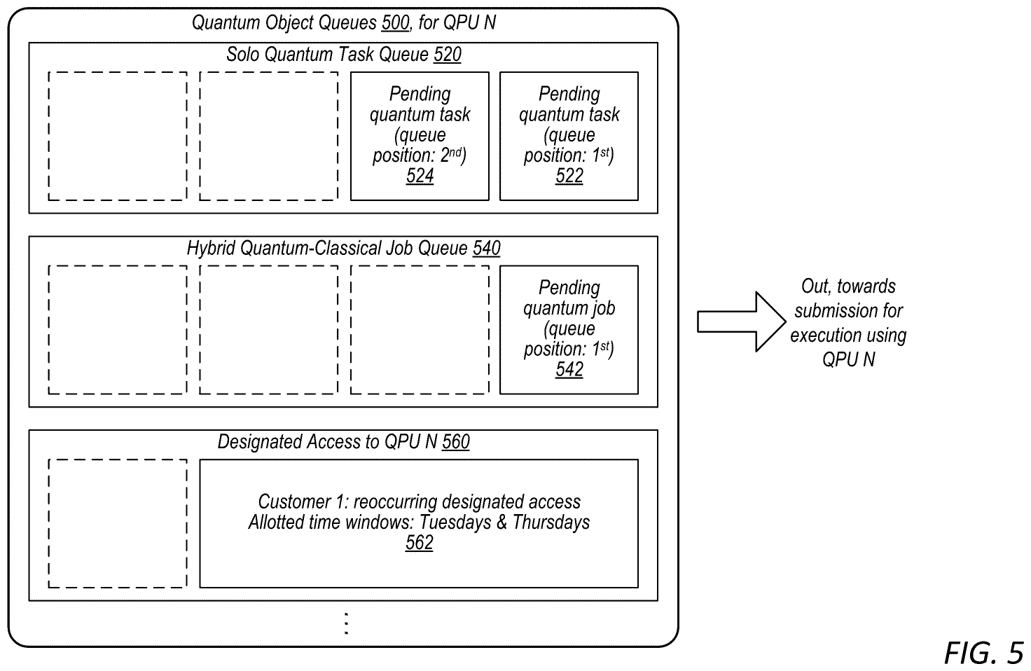

FIG. 5 illustrates some embodiments in which multiple queues per QPU may be used to logically map incoming requests from customers, according to some embodiments.

In some embodiments, queue management module 110 may be configured to logically generate several queues per QPU, and maintain the multiple queues per QPU within QPU queues 112. For example, quantum object queue 268 for QPU N, shown in FIG. 2, may additionally include one or more levels of queues, such as those shown in quantum object queues 500 of FIG. 5, according to some embodiments. For ease of discussion herein, the multiple queues depicted within quantum object queues 500 for QPU N may be referred to as “sub-queues.”

As introduced above, some quantum objects may be defined as solo or single quantum tasks, wherein the given solo quantum task includes a series of quantum circuits that are performed sequentially and/or may be repeated a given number of times. As shown in FIG. 5, solo quantum task queue 520 may be used to logically map incoming solo quantum tasks to positions in said queue, wherein, at a moment in time depicted in FIG. 5, solo quantum task queue 520 is currently being used to track pending quantum task 522, which is in a first position in the queue, and pending quantum task 524, which is in a second position in the queue.

As additionally introduced above, some quantum objects may be defined as hybrid quantum-classical jobs, wherein the given hybrid quantum-classical job includes a portion of the quantum object that is executed using a quantum computing resource and another portion of the quantum object that is executed using a classical computing resource. As shown in FIG. 5, hybrid quantum-classical job queue 540 may be used to logically map incoming hybrid jobs to positions in said queue, wherein, at a moment in time depicted in FIG. 5, hybrid quantum-classical job queue 540 is currently being used to track pending quantum job 542, which is in a first position in the queue.

Furthermore, and in some embodiments, quantum computing service 102 may be configured to provide various levels of service to respective customers, such as providing priority access tokens and/or designated access windows to certain customers based on respective agreements. For example, a given customer who applies a priority access token to their incoming request may cause queue management module 110 to logically map said incoming request to a first position within a respective queue. For instance, in some embodiments in which a customer corresponding to customer request 300 submits a priority access token in addition to quantum object 302 and associated metadata 306, quantum object 302 may then be logically mapped to a first place position within quantum object queue 268, instead of being logically mapped to a fourth place position within the queue. It may be understood that such a priority access token allows for a customer to take priority, potentially over other currently pending quantum objects, within a given queue. In such embodiments, queue management module 110 may then additionally cause the machine learning model, corresponding to QPU N, to re-generate an updated predicted wait time for one or more of the affected customers based, at least in part, on said adjustment to positions within the queue.

As shown in FIG. 5, quantum object queues 500 may include one or more additional sub-queues that may be customized for the given QPU, such as designated access to QPU N 560. As introduced in the preceding paragraph herein, quantum computing service 102 may be configured to provide a designated access window to a given customer, such that quantum objects submitted by the given customer during the agreed upon time windows may be prioritized over other pending quantum objects in other sub-queues of quantum object queues 500 (e.g., solo quantum task queue 520, hybrid quantum-classical job queue 540, etc.). As shown in block 562, customer 1 may have an agreed upon designated access to QPU N on Tuesdays and Thursdays. It should be understood that block 562 is meant to illustrate a high-level example of a designated access window, and that additional variations with regard to information provided in block 562 are still also meant to be included in the discussion herein.

In some embodiments in which quantum object queues 500 includes at least two or more sub-queues, such as that which is shown in FIG. 5, queue management module 110 may be configured to interleave pending quantum objects from respective ones of the sub-queues when submitting quantum objects to a quantum hardware provider. For example, in some embodiments in which quantum computing service 102 has an overall allotted amount of time today to execute quantum objects using QPU N, queue management module 110 may be configured to prioritize pending quantum job 542 in order to ensure that the job does not get halted, prior to completion, due to the allotted amount of time ending. In another example, queue management module 110 may be configured to pre-simulate pending quantum job 542, determine that, with the amount of allotted time left, it is not probable that pending quantum job 542 will complete execution, and therefore prioritize one or more pending quantum tasks within solo quantum task queue 520 using the remaining allotted time.

Moreover, queue management module 110 may additionally be configured to customize a number of sub-queues (e.g., generate an additional sub-queue, remove an existing sub-queue, re-allocate pending quantum objects within a given existing sub-queue to another sub-queue, etc.) depending upon a number of variables that may evolve over the course of the lifetime of a given QPU, such as current demand for a given QPU, a current backlog of pending quantum objects for a given QPU, types of quantum objects being submitted (e.g., single quantum tasks, hybrid quantum-classical jobs, etc.), a use or not of priority access tokens to a given QPU, etc.

Example embodiments of queues, such as those shown in FIGS. 2 and 5 herein, demonstrate the flexibility, the customization, and the multi-tasking capabilities of quantum computing service 102 as pertaining to preparing and executing a plurality of quantum objects across a plurality of QPUs that are made accessible by service provider network 100. Furthermore, queue management module 110 may also be configured to handle non-trivial updates and/or changes to respective queues. Various additional examples pertaining to time-based evolutions of QPUs over the course of their respective lifetimes and/or non-deterministic properties of certain susceptible quantum technologies (e.g., recalibration of a QPU, etc.) may similarly cause queue management module 110 to adaptively re-select a given queue to place a quantum object into, re-map respective queue positions, and/or re-confirm submission of a given quantum object following a moment in time in which a given QPU is momentarily taken offline and brought back online again.

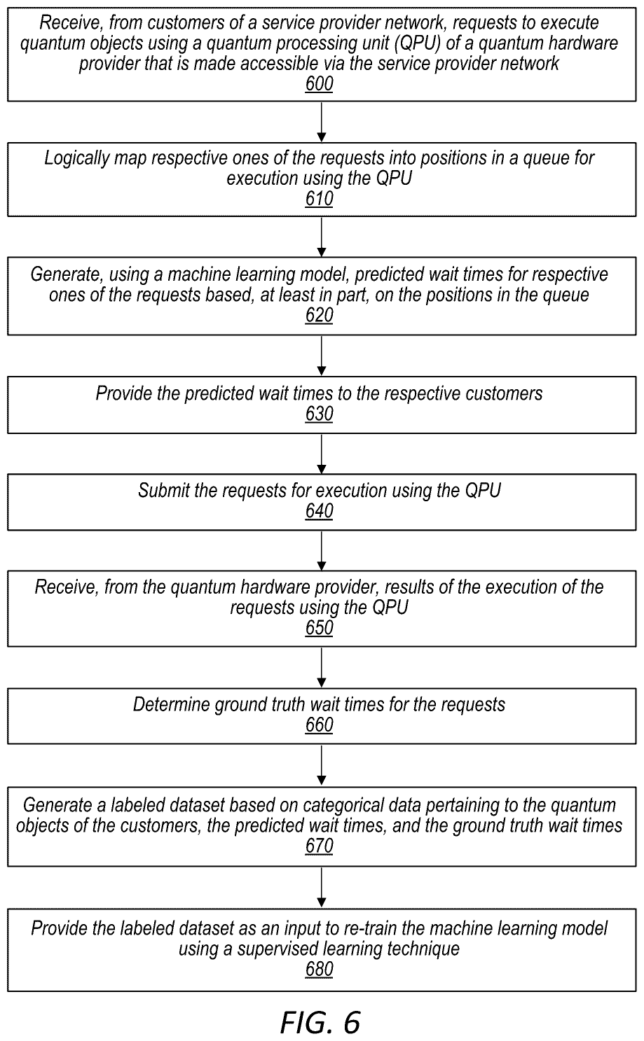

FIG. 6 is a flowchart illustrating a process of receiving an incoming request from a customer, generating an expected wait time in a queue using a machine learning model, and proceeding to submit the customer's request for execution, according to some embodiments.

In order to comprehend a scale, at least in part, at which quantum computing service 102 may be configured to operate, blocks 600-680 in FIG. 6 refer to a plurality of customer requests, such that a corresponding labeled dataset (see block 670) may include a plurality of ground truth wait times upon which to train a machine learning model (e.g., a labeled dataset that includes more than a single line item corresponding to a one single customer request). However, it should be understood that said plurality of customer requests may refer to any number of customer requests that are received over the course of a given timeframe, and may not refer in a restrictive sense to reception of all customer requests simultaneously. Similarly, blocks 600-680 may refer to a plurality of customer requests that, ultimately, are going to be executed using the same QPU (e.g., QPU N with regard to example embodiments described in FIGS. 2-5 herein). However, it should also be understood that a process such as that which is described by blocks 600-680 may be scaled up, both for a plurality of QPUs that are made available by service provider network 100, and for training QPU-specific machine learning models for use in predicting wait times.

In block 600, customer requests are received by quantum computing service 102, wherein the respective requests correspond to requests for executing respective quantum objects using a given QPU. In some embodiments, a given customer request may include a quantum object and associated metadata, as shown in FIG. 2 herein. For ease of discussion with regard to the following blocks in FIG. 6 herein, the given QPU that is to be used to execute the customer requests received in block 600 may be assumed to be QPU N.

In block 610, the respective ones of the quantum objects, included in the customer requests, are logically mapped to positions within a queue that corresponds to QPU N. As described with regard to at least FIGS. 2 and 5 herein, there may be one or more queues corresponding to QPU N that respective ones of the quantum objects may be logically mapped to.

In block 620, a trained version of a QPU-N-specific machine learning model, such as that which is described by inference stage 450 for machine learning model 412, is used to generate predicted wait times that correspond to respective ones of the customer requests. For example, logical mapping 308, as shown in FIG. 3A herein, may refer a moment in time in which quantum object 302 is logically mapped to a fourth position within quantum object queue 268 and the moment in time in which machine learning model 412 may generate an expected wait time that corresponds to customer request 300. The generated wait time prediction may then be provided to a customer that corresponds to customer request 300, as shown in block 630.

In block 640, respective ones of the quantum objects are submitted for execution using QPU N, according to their respective positions within the queue. In block 650, upon completion of the execution of a given quantum object, execution results may be received by quantum computing service 102 from a quantum hardware provider that supplies QPU N.

In block 660, quantum computing service 102 may be configured to determine a ground truth wait time for respective ones of the requests. As additionally described above, a ground truth wait time, determined by quantum computing service 102, may correspond to an amount of time that actually elapsed between when a customer first submitted their request to quantum computing service 102 and when execution of their request using QPU N began, and/or may correspond to an amount of time that actually elapsed between when a customer first submitted their request to quantum computing service 102 and when execution of their request using QPU N completed.

In block 670, a labeled dataset may be generated using any combination of information gathered in a process of preparing and executing a customer's quantum object. For example, categorical data, such as that which is included in associated metadata 306, may be provided as an input for training a machine learning model. In another example, starting queue positions of respective customer requests may be provided as an input for training a machine learning model. Such inputs may be used by a machine learning model, which may attempt to predict an expected wait time during a supervised training stage, as shown in block 680. As additionally shown in FIG. 4A, a predicted wait time, generated by the machine learning model during said training stage, may be compared to a ground truth wait time that quantum computing service 102 has previously determined, allowing said machine learning model to be trained for future moments in which unlabeled inputs (e.g., quantum object 452 and associated metadata 454) are provided.

FIG. 7 illustrates edge computing devices of a quantum computing service physically located at quantum hardware provider locations, according to some embodiments.

In some embodiments, service provider network 100, as illustrated in FIG. 1, may include one or more data centers connected to each other via private or public network connections. Also, edge computing devices located at quantum hardware provider locations may be connected to a service provider network via private or public network connections. For example, service provider network 100 illustrated in FIG. 7 includes data centers 706a, 706b, 706c, and 706d that are connected to one another via private physical network links of the service provider network 100. In some embodiments, a customer of the service provider network may also be connected via a private physical network link that is not available to the public to carry network traffic, such as a physical connection at a router co-location facility. For example, customer 712 is connected to a router associated with data center 706d via direct connection 724. In a similar manner, edge computing devices located at quantum hardware provider locations may be connected to a service provider network via a private physical network link that is not available to carry public network traffic.

For example, edge computing device 704a located at quantum hardware provider location 702a is connected to a router at data center 706a via direct connection 716. In a similar manner, edge computing device 704b at quantum hardware provider location 702b is connected to a router at data center 706b via direct connection 718; edge computing device 704c at quantum hardware provider 702c is connected to a router at data center 706c via direct connection 720; and edge computing device 704d at quantum hardware provider 702d is connected to a router at data center 706d via direct connection 722.

Also, in some embodiments an edge computing device of a service provider network located at a quantum hardware provider location may be connected to the service provider network via a logically isolated network connection over a shared network connection, such as via the Internet or another public network. For example, edge computing device 704e at quantum hardware provider location 702e is connected to data center 706d via a logically isolated network connection via network 714. In a similar manner, in some embodiments a customer, such as customer 708, may be connected to service provider network 100 via public network 710.

In some embodiments, a quantum computing service, such as quantum computing service 102, may be implemented using one or more computing devices in any of data centers 706a, 706b, 706c, 706d, etc. Also, quantum computing service 102 may provide customers, such as customer 708 or customer 712, access to quantum computers in any of quantum hardware provider locations 702a, 702b, 702c, 702d, 702e, etc. For example, a customer may not be restricted to using a quantum hardware provider in a local region where the customer is located. Instead, the customer may be allocated compute instances instantiated on a local edge computing device located at a selected quantum hardware provider location, such that the location of the customer does not restrict the customer's access to various types of quantum computing technology-based quantum computers.

In some embodiments, one or more of the data centers 706 may also include local quantum hardware devices, such as local QPUs 726. A person having ordinary skill in the art should understand that local QPUs 726 may “local” since they are located within service provider network 100, while QPUs located at quantum hardware provider premises, such as quantum hardware provider locations 702a, 702b, 702c, 702d, and 702e, may be located external to service provider network 100.

### Example Edge Computing Device Located at a Quantum Hardware Provider Location

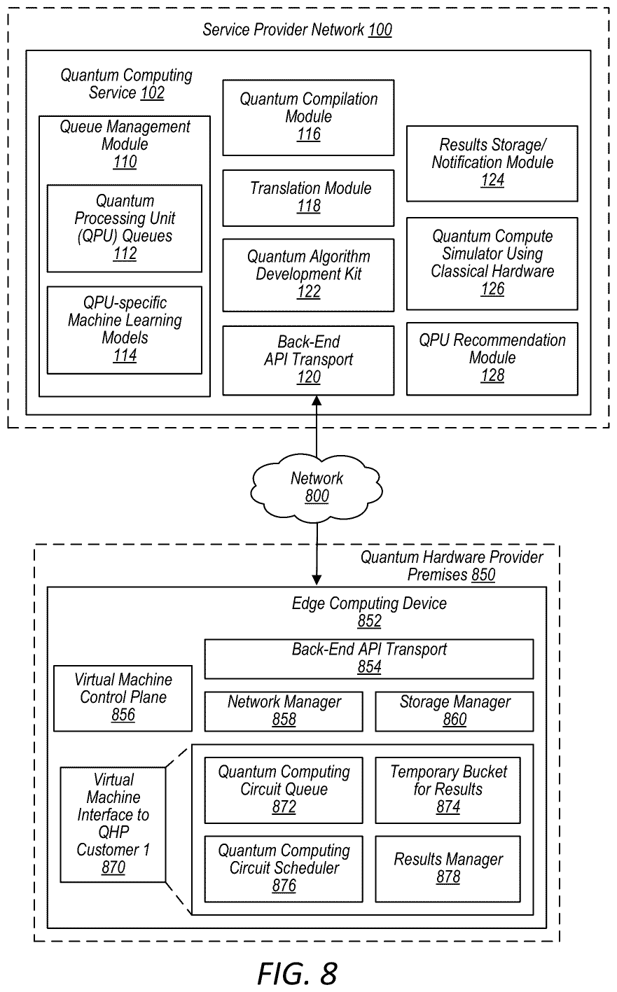

FIG. 8 illustrates an example edge computing device connected to a quantum computing service, according to some embodiments.

Service provider network 100 and quantum computing service 102, shown in FIG. 8, may provide similar functionalities to the service provider networks and quantum computing services described herein, such as in FIG. 1. Also, edge computing device 852 may be a similar edge computing device as any of the edge computing devices described previously, such as in FIG. 1 or 7. Edge computing device 852 may be connected to service provider network 100 via network connection 800, which may be a logically isolated network connection via a public network, a dedicated physical non-public network link, or other suitable network connection.

Edge computing device 852 may include network manager 858, storage manager 860, and virtual machine control plane 856.

In some embodiments, a back-end application programmatic interface (API) transport of an edge computing device, such as back-end API transport 854 of edge computing device 852 may ping a quantum computing service to determine if there are one or more quantum tasks (e.g., quantum circuits) waiting to be transported to the edge computing device. The edge computing device may further use a non-public back-end API transport, such as back-end API transport 854 to bring the quantum circuit into the edge computing device 852.

Additionally, for each customer, a back-end API transport of an edge computing device of a quantum computing service, such as back-end API transport 854 of edge computing device 852, may cause a virtual machine to be instantiated to manage scheduling and results for a given quantum circuit pulled into the edge computing device from a back-end API. For example, virtual machine 870 may act as an interface to the quantum hardware provider for a given customer (e.g., customer 1) of the service provider network. The edge computing device may be directly connected to a local non-public network at the quantum hardware provider location and may interface with a scheduling component of the quantum hardware provider to schedule availability (e.g., usage slots) on a quantum computer of the quantum hardware provider.

In some embodiments, the virtual machine 870 may be booted with a particular quantum machine image that supports interfacing with the scheduling component of the quantum hardware provider, wherein different quantum hardware providers require different scheduling interfaces.

In some embodiments, virtual machine 870 may be booted with a quantum circuit queuing component 872, a quantum circuit scheduling component 876, a component that manages a local storage bucket on the edge computing device to temporarily store results, such as temporary bucket 874 and results manager 878. In some embodiments, quantum circuit scheduling component 876 may order quantum circuits in quantum circuit queuing component in the order they are received, wherein the received order enforces quality of service (QOS) guarantees by ordering the quantum tasks in the quantum task queue of the quantum computing service based on priorities determined using the QoS guarantees.

In some embodiments, an edge computing device, such as edge computing device 852, may support multi-tenancy (e.g., service multiple customers of service provider network 100). Also, in some embodiments, edge computing device 852 may also instantiate virtual machines that execute classical computing tasks, such as a classical computing portion of a hybrid algorithm. For example, virtual machine 870 may be further configured to perform classical compute portions of a hybrid algorithm.

In some embodiments, a back-end API transport of an edge computing device located a quantum hardware provider location may interface with a back-end API transport interface 120 of a computing device/router at a remote location where one or more computing devices that implement the quantum computing service are located.

Note that edge computing device 852 may be physically located (e.g., co-located) at quantum hardware provider premises 850, such as in a building of a quantum hardware provider facility.

In some embodiments, the components of virtual machine 870 may be included in back-end API transport 854, and the back-end API transport 854 may execute the related components within the back-end API transport without causing a separate VM 870 to be instantiated.

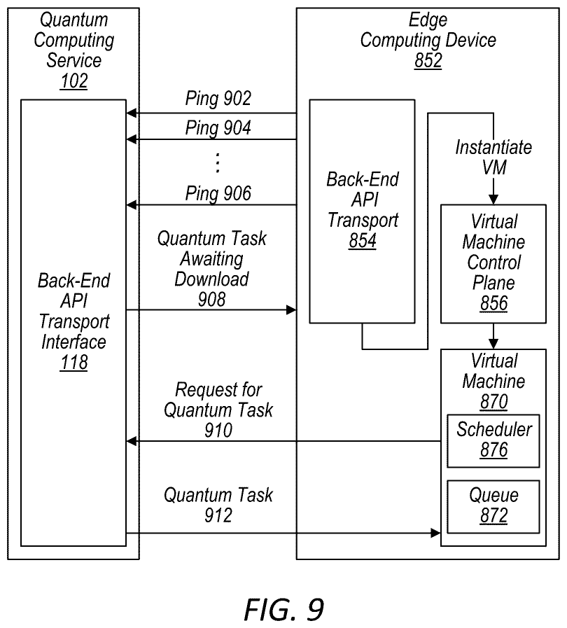

FIG. 9 illustrates example interactions between a quantum computing service and an edge computing device of the quantum computing service, according to some embodiments.

A back-end API transport 854 of edge computing device 852 may submit pings 902, 904, 906, etc. to quantum computing service 102 to determine whether there is a quantum task (e.g., one or more quantum circuits) to be transported to edge computing device 852. At 908, the quantum computing service 102 may indicate to the edge computing device 852 that there is a translated quantum circuit ready to be transported to the edge computing device 852. In response, back-end API transport 854 may cause virtual machine control plane 856 to instantiate a virtual machine 870 to act as an interface for the customer to the quantum hardware provider. At 910 the VM 870 may call the back-end API transport 854 requesting the translated quantum circuit (e.g., quantum task or batch of quantum tasks). In response, at 912, the back-end API transport 854 may cause the translated quantum circuit (e.g., quantum task or batch of quantum tasks) to be transported to the queue 872 of VM 870. In some embodiments, instead of pings of a polling protocol, an edge computing device 852 may use various other techniques to determine whether there is a quantum computing circuit (e.g., quantum task or batch of quantum tasks) ready to be transported to edge computing device 852. Also, in some embodiments, a given quantum hardware provider may include more than one quantum computer and/or types of quantum computers. In such embodiments, a back-end API transport and/or VM interface to the quantum hardware provider may route a quantum circuit that is to be executed at the quantum hardware provider to an assigned quantum computer at the quantum hardware provider.

In some embodiments, quantum tasks may come over to queue 872 with associated access tokens and the quantum tasks may be ordered in queue 872 based on their respective access tokens, or time stamps included in the respective access tokens.

### Illustrative Computer System

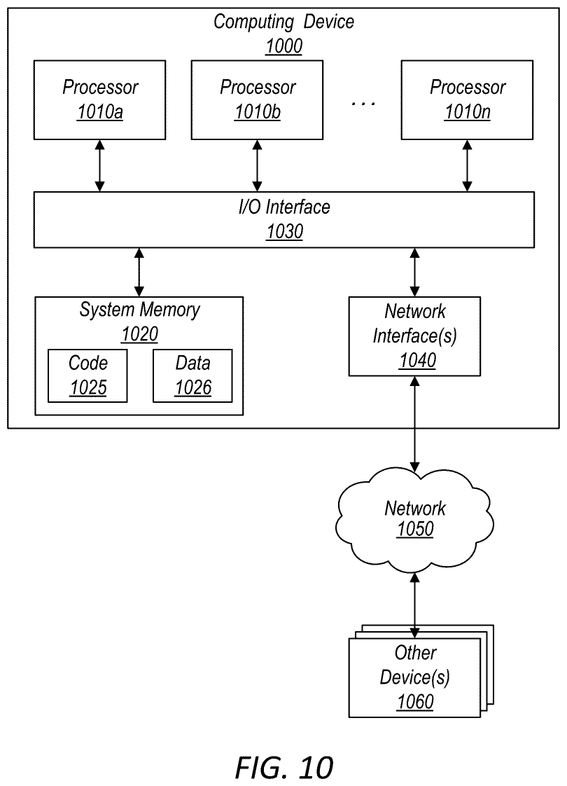

FIG. 10 is a block diagram illustrating an example computing device that may be used in at least some embodiments.

FIG. 10 illustrates such a general-purpose computing device 1000 as may be used in any of the embodiments described herein. In the illustrated embodiment, computing device 1000 includes one or more processors 1010 coupled to a system memory 1020 (which may comprise both non-volatile and volatile memory modules) via an input/output (I/O) interface 1030. Computing device 1000 further includes a network interface 1040 coupled to I/O interface 1030.

In various embodiments, computing device 1000 may be a uniprocessor system including one processor 1010, or a multiprocessor system including several processors 1010 (e.g., two, four, eight, or another suitable number). Processors 1010 may be any suitable processors capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA. In some implementations, graphics processing units (GPUs) may be used instead of, or in addition to, conventional processors.

System memory 1020 may be configured to store instructions and data accessible by processor(s) 1010. In at least some embodiments, the system memory 1020 may comprise both volatile and non-volatile portions; in other embodiments, only volatile memory may be used. In various embodiments, the volatile portion of system memory 1020 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 1020 as code 1025 and data 1026.

In some embodiments, I/O interface 1030 may be configured to coordinate I/O traffic between processor 1010, system memory 1020, and any peripheral devices in the device, including network interface 1040 or other peripheral interfaces such as various types of persistent and/or volatile storage devices. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. Also, in some embodiments some or all of the functionality of I/O interface 1030, such as an interface to system memory 1020, may be incorporated directly into processor 1010.

Network interface 1040 may be configured to allow data to be exchanged between computing device 1000 and other devices 1060 attached to a network or networks 1050, such as other computer systems or devices as illustrated in FIG. 1 through FIG. 9, for example. In various embodiments, network interface 1040 may support communication via any suitable wired or wireless general data networks, such as types of Ethernet network, for example. Additionally, network interface 1040 may support communication via telecommunications/telephony networks such as analog voice networks or digital fiber communications networks, via storage area networks such as Fibre Channel SANs, or via any other suitable type of network and/or protocol.

In some embodiments, system memory 1020 may represent one embodiment of a computer-accessible medium configured to store at least a subset of program instructions and data used for implementing the methods and apparatus discussed in the context of FIG. 1 through FIG. 9. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 1000 via I/O interface 1030. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computing device 1000 as system memory 1020 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 1040. Portions or all of multiple computing devices such as that illustrated in FIG. may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A system, comprising:
one or more computing devices of a service provider network configured to implement:
a quantum computing service; and
a machine learning model,
wherein the one or more computing devices that implement the quantum computing service are configured to:
receive, from customers of the service provider network, requests to execute quantum objects using a quantum processing unit (QPU) of a quantum hardware provider that is made accessible via the service provider network;
logically map respective ones of the requests into positions in a queue for execution using the QPU;
generate, using the machine learning model, predicted wait times for respective ones of the requests based, at least in part, on the positions in the queue;
provide the predicted wait times to the respective customers;
submit the requests for execution using the QPU;
receive, from the quantum hardware provider, results of the execution of the requests;
determine, based on respective times when the results are received from the quantum hardware provider, ground truth wait times for the requests;
generate a labeled dataset based, at least in part, on:
information pertaining to the quantum objects of the customers;
the predicted wait times; and
the ground truth wait times; and
provide the labeled dataset as an input to re-train the machine learning model using a supervised learning technique.

2. The system of claim 1, wherein to re-train the machine learning model using the supervised learning technique, the one or more computing devices configured to implement the machine learning model are configured to:
generate a simulated queue for quantum objects using the information pertaining to the quantum objects of the customers, provided within the labeled dataset;
generate simulated wait times for respective ones of the quantum objects based, at least in part, on logically mapped positions within the simulated queue; and
compare a difference between the simulated wait times and the ground truth wait times, provided within the labeled dataset.

3. The system of claim 2, wherein to generate simulated wait times for respective ones of the quantum objects, the one or more computing devices configured to implement the machine learning model are configured to:
analyze categorical data within the information pertaining to the quantum objects of the customers;
assign predicted durations of time for executing respective ones of the quantum objects using the QPU based, at least in part, on the categorical data; and
apply the predicted durations of time to the logically mapped positions within the simulated queue.

4. The system of claim 3, wherein:
the categorical data, corresponding to respective ones of the quantum objects of the customers, comprises problem domains; and
the problem domains comprise one or more of the following:
an optimization problem domain;
a manufacturing problem domain;
a chemistry problem domain;
a physics problem domain;
a finance problem domain;
a pharmaceutical problem domain;
a biotechnology problem domain;
a medical problem domain;
an information security problem domain; or
a machine learning problem domain.

5. The system of claim 1, wherein the one or more computing devices that implement the quantum computing service are further configured to:
receive, from the quantum hardware provider, an indication that the QPU has been recalibrated, wherein the indication comprises results of a recalibration protocol executed using the QPU;
generate metadata for the requests indicating one or both of the following:
the results of the calibration protocol; or
respective amounts of time that has elapsed since the QPU has been recalibrated; and
provide the generated metadata as an additional input in the labeled dataset used to re-train the machine learning model using the supervised learning technique.

6. The system of claim 5, wherein to re-train the machine learning model using the supervised learning technique, the one or more computing devices configured to implement the machine learning model are further configured to:
include a recalibration age, with respect to an amount of time that has elapsed since the indication that the QPU has been recalibrated, as a performance metric of the QPU, used by the machine learning model; and
adjust simulated wait times for respective ones of the customers' quantum objects based, at least in part, on an improvement or degradation of the performance metric of the QPU with respect to the elapsed amount of time since recalibration.

7. The system of claim 1, wherein the one or more computing devices that implement the quantum computing service are further configured to:
receive, from the quantum hardware provider, execution results corresponding to the submitted requests, executed using the QPU;
generate characterization information for the QPU based, at least in part, on the execution results; and
provide the characterization information for the QPU as an additional input in the labeled dataset used to re-train the machine learning model.

8. The system of claim 7, wherein to re-train the machine learning model using the supervised learning technique, the one or more computing devices configured to implement the machine learning model are further configured to:
compare the generated characterization information for the QPU to previously generated characterization information for the QPU; and
adjust simulated wait times for respective ones of the customers' quantum objects based, at least in part, on an improvement or degradation of the characterization information of the QPU.

9. The system of claim 1, wherein the one or more computing devices that implement the quantum computing service are further configured to:
receive, from a given customer of the service provider network, another request to execute another quantum object, wherein the request comprises:
a constraint to view the predicted wait times prior to providing a selection of a given QPU to be used to execute the other quantum object;
provide the predicted wait times to the given customer; and
receive, from the given customer, an indication of a QPU selection based, at least in part, on the provided predicted wait times.

10. The system of claim 1, wherein the requests comprise one or more of the following:
a given quantum object that comprises one or more quantum circuits, repeated one or more times; or
another quantum object that comprises a hybrid, quantum-classical job.

11. A system, comprising:
one or more computing devices of a service provider network configured to implement:
a quantum computing service; and
a machine learning model,
wherein the one or more computing devices that implement the quantum computing service are configured to:
receive, from a customer of the service provider network, a request to execute a quantum object using one of a plurality of a quantum processing units (QPUs) of quantum hardware providers that are made accessible via the service provider network;
generate, using the machine learning model, predicted wait times for respective ones of the QPUs based, at least in part, on already pending quantum objects in queues corresponding to the respective ones of the QPUs;
provide a recommendation to the customer of one or more possible QPUs to be used to execute the request, wherein the recommendation comprises the predicted wait times;
receive an indication, from the customer, of a QPU selection to be used to execute the request;
logically map the request into a position in the queue corresponding to the selected QPU;
submit the request for execution using the selected QPU;
receive, from a quantum hardware provider of the selected QPU, results of the execution of the request using the selected QPU;
determine a ground truth wait time for the request; and
provide the predicted wait time and the ground truth wait time for use in generation of a subsequent labeled training dataset to be used to re-train the machine learning model using a supervised learning technique.

12. The system of claim 11, wherein:
the recommendation comprises:
a first predicted wait time that corresponds to a first QPU of the plurality of QPUs; and
a second predicted wait time that corresponds to a second QPU of the plurality of QPUs, wherein the second predicted wait time is a longer amount of time than the first predicted wait time; and
the QPU selection, received in the indication from the customer, indicates the first QPU to be used to execute the request.

13. The system of claim 11, wherein:
the recommendation comprises a predicted wait time that corresponds to a first QPU of the plurality of QPUs; and
the QPU selection, received in the indication from the customer, indicates that a different QPU, besides the first QPU, should be used to execute the request.

14. The system of claim 11, wherein:
the request from the customer comprises a constraint to select a QPU of the plurality of QPUs with a shortest predicted wait time;
the recommendation comprises a predicted wait time that corresponds to a first QPU of the plurality of QPUs, wherein the predicted wait time is shorter than other predicted wait times corresponding to the respective other ones of the QPUs; and
the QPU selection, received in the indication from the customer, indicates the first QPU to be used to execute the request.

15. The system of claim 14, wherein the one or more computing devices that implement the quantum computing service are further configured to:
subsequent to the reception of the indication from the customer to use the first QPU to execute the request,
receive, from another customer of the service provider network, another request to execute a quantum object, wherein the other request comprises a priority access token to the first QPU of the plurality of QPUs;
logically map the other request to a first place position in a queue for execution using the first QPU, wherein the request from the customer is logically repositioned in a position behind the first place position;
generate, using the machine learning model, updated predicted wait times for the respective ones of the QPUs; and
provide an updated recommendation to the customer whose request comprises the constraint to select the QPU with the shortest predicted wait time.

16. The system of claim 11, wherein the one or more computing devices that implement the quantum computing service are further configured to:
subsequent to the reception of the indication from the customer of the selected QPU to be used to execute the request,
receive, from another customer of the service provider network, another request to execute a quantum object, wherein the other request comprises a priority access token to the selected QPU;
logically map the other request to a first place position in a queue for execution using the selected QPU, wherein the request from the customer is logically repositioned to a position behind the first place position;
generate, using the machine learning model, an updated predicted wait time for the selected QPU based, at least in part, on the logical repositioning; and
provide the updated predicted wait time to the customer.

17. The system of claim 11, wherein to re-train the machine learning model using the supervised learning technique, the one or more computing devices configured to implement the quantum computing service are configured to:
generate a labeled dataset pertaining to the selected QPU based, at least in part, on:
information pertaining to the quantum object of the customer;
the predicted wait time; and
the ground truth wait time; and
provide the labeled dataset as an input to re-train the machine learning model using the supervised learning technique.

18. The system of claim 11, wherein:
at least one of the QPUs made accessible by the service provider network is a QPU located externally to the service provider network; or
at least another one of the QPUs made accessible by the service provider network is a QPU located internally to the service provider network.

19. A method, comprising:
receiving, from customers of a service provider network, requests to execute quantum objects using a quantum processing unit (QPU) of a quantum hardware provider that is made accessible via the service provider network;
logically mapping respective ones of the requests into positions in a queue for execution using the QPU;
generating, using a machine learning model, predicted wait times for respective ones of the requests based, at least in part, on the positions in the queue;
providing the predicted wait times to the respective customers;
submitting the requests for execution using the QPU;
receiving, from the quantum hardware provider, results of the execution of the requests using the QPU;
determining ground truth wait times for the requests;
generating a labeled dataset based, at least in part, on:
information pertaining to the quantum objects of the customers;
the predicted wait times; and
the ground truth wait times; and
providing the labeled dataset as an input to re-train the machine learning model using a supervised learning technique.

20. The method of claim 19, further comprising:
re-training the machine learning model, wherein said re-training comprises:
generating a simulated queue for quantum objects using the information pertaining to the quantum objects of the customers, provided within the labeled dataset;
generating simulated wait times for respective ones of the quantum objects based, at least in part, on logically mapped positions within the simulated queue; and
comparing a difference between the simulated wait times and the ground truth wait times, provided within the labeled dataset.
